(19) United States
(12) Patent Application Publication
(10) Pub. No.: US 2012/0110669 A1
(43) Pub. Date: May 3, 2012

(54) METHOD AND SYSTEM FOR ANALYZING AN ENVIRONMENT

(76) Inventors: Yolanta Beresnevichiene, Bristol (GB); Adrian John Baldwin, Bristol (GB); Jonathan F. Griffin, Bristol (GB); Simon K.Y. Shiu, Bristol (GB); Marco Casassa Mont, Bristol (GB); Brian Quentin Monahan, Bristol (GB); David J. Pym, Aberdeen (GB)

(21) Appl. No.: 12/916,197

(22) Filed: Oct. 29, 2010

(51) Int. Cl. G06F 12/00

(52) U.S. Cl. 726/25

(57) ABSTRACT

A system for analyzing an environment to identify a security risk, comprising a model engine to generate a model of the environment using multiple components defining adjustable elements of the model and a risk analyzer to calculate multiple randomized instances of an outcome for the environment using multiple values for parameters of the elements of the model selected from within respective predefined ranges for the parameters.

### BACKGROUND

In complex and generally large scale systems and organizations such as corporate Information Technology (IT) infrastructures for example, there exist potential impacts to the security of the system. Such security vulnerabilities, even if they can be discovered and defined in a meaningful way, are typically difficult and costly to assess. This can be because of the number and nature of the vulnerabilities for example, as well as the number of assets present in such large systems, all of which can have an impact on potential solutions which vary greatly.

Typically, methodologies for examining an organization's security posture and for identifying potential gaps in security investments proceed by decomposing the overall security issue into a set of potential risks, and then using these to estimate the likelihood and impact of each risk on the organization. Accordingly, it is then typically possible to identify some form of controls for the potential risks and to define the costs associated with these controls. A residual risk once a control is deployed can then be calculated and appropriate investments in security can thus be determined.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a schematic block diagram of a method for analyzing an environment according to an example;

FIG. 2 is a schematic block diagram of a model engine according to an example;

FIG. 3 is a schematic block diagram of a process for performing a set of calculations using a risk analyzer according to an example;

FIG. 4 is a schematic block diagram of a system according to an example;

FIG. 5 is a schematic block diagram of a system according to an example;

FIG. 6 is a schematic block diagram of a system according to an example;

FIG. 7 is a schematic block diagram of a system according to an example;

FIG. 8 is a schematic block diagram of a system according to an example; and

FIG. 9 is a schematic block diagram of a method for analyzing an environment according to an example.

### DETAILED DESCRIPTION

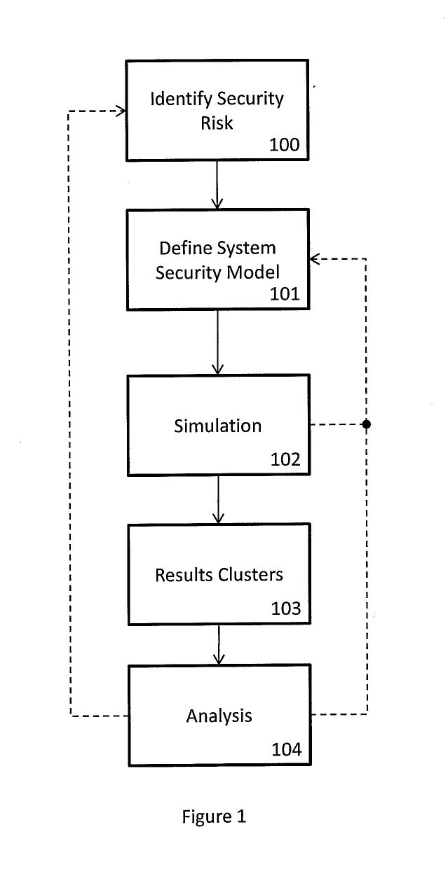

FIG. 1 is a schematic block diagram of a method for analyzing an environment, or portion thereof, in which a potential security risk may exist according to an example. In block 100 a potential security risk is identified. This can include a characterization of an issue, such as a characterization provided by a decision-maker in an organization for example (e.g., a client organization's Chief Information Security Officer—CISO). For example, the organization may consider investing in specific solutions to better manage access privileges of its users. Associated with this investment, the CISO has a range of choices for the nature of the resulting system configuration, including security controls and specific solutions, and a range of preferences among the security outcomes. The identified security risk could therefore be a risk associated with a lack of implementation of access controls for example. According to an example, this is a discovery or identification phase.

In block 101, the dynamics of the outcomes determined in the identification phase are explored by constructing an executable system security model of the environment in which the security risk may exist or potentially exist in the context of its dynamic threat and economic environments. Accordingly, in this stage architectural, policy, business process, and behavioral constraints which are inherent in the security risk are captured and formalized. According to an example, threat environment characteristics such as potential attacker behavior, threat vectors and probabilities and other externalities that may influence an internal business process or human behavior in the organization are identified and captured as events. The stage can include observations of stages and decision points of the system involved. According to an example, the modeling cycle can be repeated until a model is determined to sufficiently capture the decision making situation. In the example of access control, a model can define the way in which the organization in question will be affected if (and how) certain access control systems are implemented. Accordingly, the model can be used to demonstrate a security risk for the environment in the wake of a lack of a particular implementation, or an implementation not aligned with operational characteristics of the organization or not appropriately addressing the risk.

According to an example, defining a model 101 or representation includes using a set of internal and external components to represent aspects of the environment and security risk under consideration, which aspects may influence the environment and security risk, and influence the way in which the risk affects an organization embodied by the representation of the environment. External components may correspond to a threat environment and can include the rate of discovery of vulnerabilities, a speed to develop exploits, a speed to develop patches and signatures, attacker behavior etc. Internal components can include specific tasks undertaken in security operations, a speed with which these tasks are undertaken, a length of time to undertake the tasks and specific security solutions and mechanisms and their properties. This might also include behavioral aspects that affect security, such as personnel movements and habits (such as writing a password down for example). Components can be static or dynamic—that is to say, a component can have a behavior in a model which is dependent on previous decision points, or can be a component which generates a value from an associated probability distribution such that the value can change dynamically in response to repeated runs of a model and in response to an input value received by the component (which affects the output).

In deriving a model or representation, considerations which include the investment choices which can be made, and a set of measures representing a search domain for choices can be taken into account. For example, a particular investment choice could include the provision of installing biometric sensors at various locations and with varying complexity at certain positions within an organization. Accordingly, a search domain for the choices can include ranges associated with a number, location and complexity of sensors. Variation of these parameters within the defined ranges will typically result in multiple outcomes which affect the way in which an associated security risk may (or may not) be mitigated—in this context a risk may include denying access to authorized personnel, or a failure to install a sensor in a location thereby allowing access where it should actually be more strictly controlled. According to an example, a search domain or range for a parameter can be derived in an identification phase based on characteristics of the environment to be modeled, and based on how the risk is managed in an organization embodied by the representation of the environment. It can be modified in response to an indication that the range is not suitable. For example, for a given search range, a set of outcomes can lead to a conclusion that the range needs to be altered in order to encompass a different space of results which may be more suitable for determining how to mitigate a certain risk. According to an example, a model or representation can be a graphical model or representation, or a representation provided in another form, such as a textual representation for example, in which aspects of a model are represented by respective portions of marked up text for example.

In block 102, the model of block 101 is used in order to generate data in the form of results clusters 103 which can be used for analyzing (block 104) the environment (or portion thereof) in view of the risk or solution. That is to say, using the model, behavior is simulated using the representation of a dynamic threat and economic environment by exploring the search domains in order to provide results clusters 103 which can be in the form of multiple output configurations for the environment. The output configurations can represent outcomes associated with choices which can be made to mitigate the effects of a security risk. Results and conclusions can be validated against the preferences of the decision-maker, such as the CISO for example. In case they do not match the preferences, further refinement of the risk or components can take place. Alternatively, if a search domain is determined to be unsuitable it can be widened or narrowed in scope.

Accordingly, a system according to an example uses a model corresponding to a characterization of a risk or issue in a dynamic threat environment determined in an identification phase to provide a set of output calculations which are used to determine a solution, perhaps including refinement of the initial risk identification and/or model. As indicated by dotted lines in FIG. 1, an identified risk and/or a model can be refined or altered in response to findings from a simulation or analysis phase.

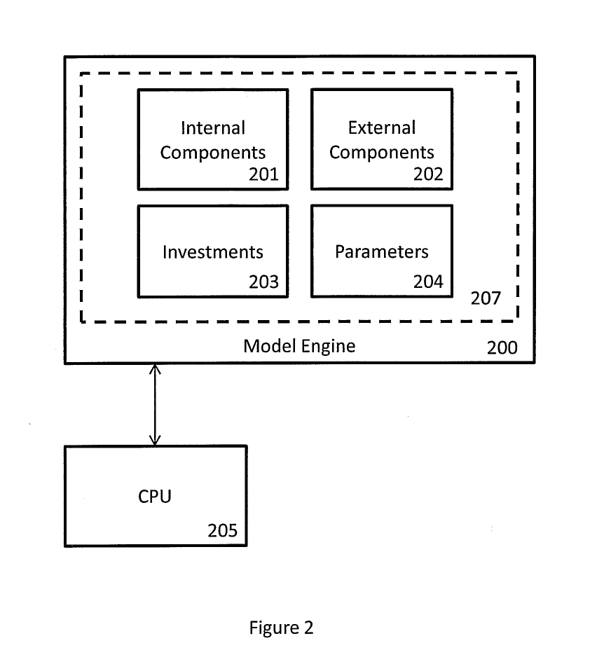

FIG. 2 is a schematic block diagram of a model engine according to an example. Model engine 200 is used to define and build a model for an environment, portion thereof or a system in which a security risk or other such issue can be present or a potential threat. A model engine 200 uses a set of internal 201 and external 202 components to form a model 207. Engine 200 further includes data representing a set of investment choices 203, and a set of related parameters 204 for the model 207. Parameters 204 affect stochastic randomized elements within the model 207. Typically, parameters 204 can vary over a range defining a desired or acceptable interval for a particular metric associated with a change. As a simple example, the implementation of biometric sensors in an environment in order to shore up access control will typically involve a financial investment. An associated set of parameters would be a number of sensors to be installed in the environment, as well as the location and complexity of the sensors for example. Variation of these parameters within a given interval will lead to a number of outcomes based on the investment in view of the external threat environment.

According to an example, the model engine 200 can be functionally linked to a processor 205 (CPU) for performing calculations for the engine. Other connections to the model engine 200 have been omitted in FIG. 2 for the sake of clarity. Internal 201 and external 202 components define elements of the model 207. Investments 203 include data representing a set of changes which can be made in an environment such as an organization according to the model 207. The changes can relate to a change in any of a process, product, workflow and workforce for example. Such changes can cause an investment in time, money or other resources to be deployed. As such, the changes will typically involve some form of effort in order to be implemented—that effort can be purely financial in nature, or could involve a cost neutral change, or could be a combination of a cost and some other effort for example.

Typically, an investment 203 will be a financial investment, either direct or indirect—for example, implementing a new process, tool, product or workflow to mitigate the effects of an identified security risk, and/or releasing some proportion of a workforce to perform tasks aimed at mitigating the risk, and/or engaging additional workforce. Some investments may be less straightforward to quantify. For example, an investment in a behavioral change such as a change in a process or workflow which is performed by some proportion of a workforce, can be parameterized in various different ways. One possible way to parameterize such an investment could be by determining a temporal range as a result of possible delays to some portion of a workflow as a result of a change intended to make the workflow more robust, such as by a person interposing on certain actions to verify consistency and/or accuracy for example.

According to an example, engine 200 is therefore used to generate a model 207 for a system or environment in which there may be a security risk using multiple ones of the internal 201 and external 202 components, which components define adjustable elements of the model 207. The components and the relationships and functional links between the components define the model (relationships can be causal, communication of data, links to shared resources or queues, etc.). The generated model is used to perform a set of calculations to explore a space of outcomes using different intervals for multiple parameters 204, such as under different investment choices or under specific conditions in the threat environment for example. According to an example, a risk analyzer is used to perform calculations in a consistent manner. It supports the process of defining discrete combinations of parameter variations (experimental cases) and can generate/manage structures to hold simulation data, perform repeated randomized runs within each experimental case, and gather basic statistics for each experimental case, including confidence intervals (standard error) for example.

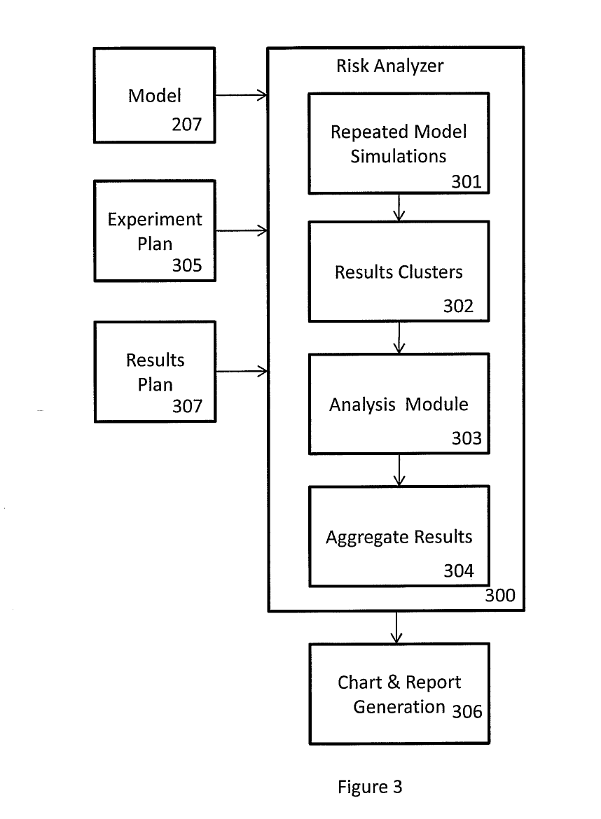

FIG. 3 is a schematic block diagram of the process for performing a set of calculations using a risk analyzer 300 according to an example. Output from risk analyzer 300 is typically determined by several pieces of information—the given model 207, an experiment plan 305, and a results plan 307. The model 207 identifies the system to be investigated in terms of its process behavior. This process behavior is subject to the (numerical and structural) parameters 204 that affect stochastic randomized elements within the model. An experiment plan 305 sets out which of the parameters 204 are to be varied and what the variation will be (typically in terms of ranges or intervals, as described). Parameter values may also be discrete symbolic expressions. According to a results plan 307, a bulk dataset of multiple results clusters 103, 302 is generated within the scope of the experiment plan 305. For example, an experiment plan 305 may specify that a certain parameter be varied within a given range—each discrete value of that parameter within the specified range can provide a results cluster. A results plan 307 identifies results to present from the generated results clusters 103, 302. For example, as described, multiple results clusters 103, 302 may include data representing the effect of variation of a parameter in a specified range. A results plan 307 can specify that data from multiple such clusters 103, 302 be used to generate a visual representation of the way in which variation of the parameter affects a potential security risk in the environment.

Accordingly, a set of parameters 204 of a model 207 are varied in a set of repeated randomized simulation runs 301 according to an experiment plan 305 which includes data representing which of parameters 204 to vary, a range for the variation, and an associated granularity for the variation (such that variations are performed in integer multiples of units of the parameter in question, or some other multiple for example). An experiment plan 305 and a results plan 307 can be provided in terms of a simple text format or in another marked up format such as XML for example. In order to cause randomization in the runs, each run within each case is provided with a random seed that is used to prime a pseudo-random number generator that provides for the randomized choices made during a simulation. These initial ‘seed’ values are provided in terms of an independently generated list of random integers (a seed file). For example, if a model of an environment E in which there exists a security risk S1 comprises multiple components {C}=[C1, C2, . . . Cn], with an associated set of parameters {P}=[P1, P2, . . . Pm] representing adjustable measures for the components (wherein each component in {C} may have multiple parameters associated with it), an experiment plan 305 can define which of the {P} are adjusted and a range for adjustment. So for example, if experiment plan 305 describes that a subset of {P} be used, an initial seed can be used to generate random numbers which are used to determine values for these parameters (within their respective ranges). Each set of values for parameters forms a ‘run’, so that multiple runs are performed within the search scope of parameters, thereby providing results clusters 103, 302 (i.e. multiple output configurations calculated using the risk analyzer 300). In this way, the search space for parameters can be explored. That is to say, repeated runs of model simulations 301 are performed according to the experiment plan within the search intervals defined and using the list of random numbers. The output from a set of repeated runs forms a results cluster 103, 302 representing the set of possible outcomes according to the randomized runs using the model in view of the experiment plan. An analysis module 303 can take the clusters 103, 302 as input and can aggregate the results 304 according to the results plan 307. In this connection, aggregating results in block 304 of analyzer 300 allows data from multiple experiments (multiple results clusters 103, 302) to be presented in a manner that is comprehensible to the stakeholders and that usefully shows outcomes in terms of risk exposure. Representation can be done in the form of charts and tables and to support this, a charting and report generation component 306 can be used. Component 306 can calculate statistical results/information gathered over runs. For example, histograms can be calculated to show frequency plots of how many values fall within particular ranges (bins). These can be useful descriptions of probability information and indicate where the most frequent range of values arises. Also, time series charts can be provided to show how selected quantities vary over time.

A different experiment plan can specify that a different subset of {P} is used—for example, to explore the way in which different investment choices can affect a situation or risk. Accordingly, corresponding clusters of results can be obtained which may be different even though the same model is used. According to an example, a specific investment choice can be explored using outputs from risk analyzer 300 operating under different experiment plans 305.

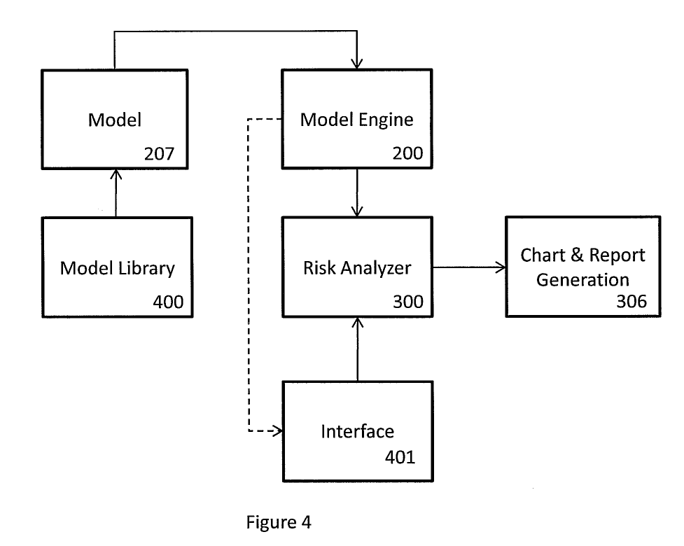

FIG. 4 is a schematic block diagram of a system according to an example. A model library 400 includes multiple generic models for a system for analyzing a security risk. For example, model library 400 can include common or nonspecific model templates which can be augmented or amended based on the specific security risk or environment under consideration. A model 207 for a risk is selected from model library 400 and input to model engine 200. According to an example, the model engine 200 receives data representing a model and can translate (or compile) objects or components from the model to machine readable code. An intermediate action can be used according to an example, in which objects or components are compiled into intermediate instructions for the system which can then be compiled into fully machine readable instructions.

According to an example, each model component can have a unique shape type associated with it which has a corresponding class which contains machine readable instructions for communicating with the model engine 200. The shape type can be used as part of an interface for a system as described below. According to an example, the shape type for a component can be provided as a graphical representation for the component which is distinct from other components thereby allowing a user of the system to distinguish between components, such as when altering or creating a model for example. A link between graphical representations provides a logical flow for a model. The model 207 as compiled by the model engine 200 is used by the risk analyzer 300 in order to generate a set of output configurations as described above.

In block 306, chart and report generation uses the results from risk analyzer 300. An interface 401 can be used according to an example to allow users to explore and conduct investigations quickly by using the output from a modeled situation, or by allowing a user some degree of control over the way in which a situation is investigated. More specifically, interface 401 can use parameters 204 from the model engine 200 to provide multiple user adjustable options which can be used to modify parameters and/or ranges in response to output configurations. The adjustments made can cause the risk analyzer to calculate multiple new output configurations on the basis of the adjustments made without the need for a model to be regenerated in model engine 200. Accordingly, interface 401 provides an easy to understand and efficient way of allowing multiple parties to see in real time the effects that changes may have to a risk or environment. For example, for a given security risk relating to the provision of access control, an interface can allow a user to modify parameters or ranges relating to the number of points in an infrastructure adapted to increase access control. An interface 401 can also be provided which gives a user control over a model or template as will be described below.

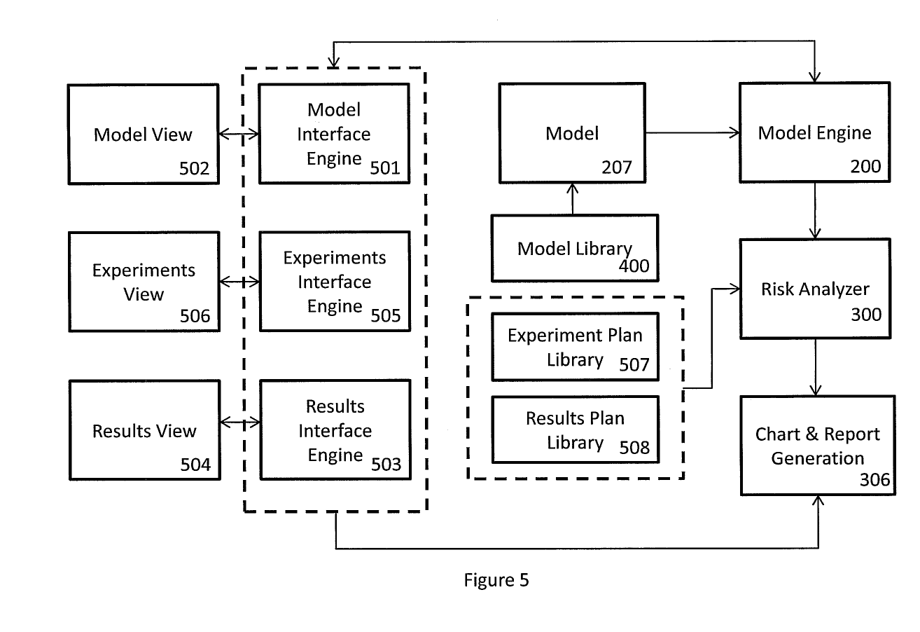

FIG. 5 is a schematic block diagram of a system according to an example. As before, a model library 400 includes a set of template models for modeling multiple different situations. The templates can be used as provided, or used as the basis for a model—that is, the templates can be amended by a user in order to more accurately represent the situation or risk being modeled. The system of FIG. 5 further includes an experiment plan library 507 and a results plan library 508. An experiment plan library 507 includes multiple files of machine readable instructions for experiments to be performed on a model from the model library 400. More specifically, the library 507 includes a set of templates for defining the way in which a model of a situation or risk can be used to generate results. For example, an experiment plan from library 507 can provide instructions representing parameters of a model to be varied in calculations and a range of variation of the parameters. Accordingly, since certain parameters from models of the model library 400 can be specific to certain situations or risks, experiment plans can be geared for generating a set of results for the specific situation in question by providing templates which affect those parameters which are relevant, such as those which may have an influence or bearing on a end result. According to an example, a model from model library 400 can have multiple relevant experiment plans associated with it, with each model/experiment plan combination providing a way of modeling a certain situation or risk.

Similarly, a results plan library 508 includes a set of multiple files of machine readable instructions defining multiple different ways in which results which have been calculated can be processed and displayed. For example, for a given model and experiment plan, results clusters 103, 302 can be generated. A results plan can use the clusters to extract certain data of interest, which can then be used in chart and report generation 306. For a given model/experiment plan combination, multiple results plans can be used to extract different data from multiple corresponding results clusters 103, 302.

According to an example, a package can be provided including a model template with an associated experiment and results plan which is defined to be applicable to a particular type of system. For example, in the field of access control, a generic and adjustable model template can be provided to model a system, and an experiments plan can be included which is predefined for generating multiple configurations for the system in response to changes in access controls. Similarly, a packaged results plan can provide access to results geared for a determination and analysis of data relating to access control.

The system of FIG. 5 further includes a model interface engine 501 and associated model view interface 502, a results interface engine 503 and associated results view interface 504, an experiments interface engine 505 and associated experiments view interface 506. The interfaces provide mechanisms for users to interact with the system of FIG. 5 in different operating modes of the system. According to an example, certain ones of the modes can be restricted and unavailable to certain users.

Results interface engine 503 drives a results view interface 504. The results view interface allows a user to make queries of the system using results which have already been generated in risk analyzer 300. For example, a given model from model library 400 in combination with an experiment plan from experiment plan library 507 and results plan from results plan library 508 are used in order to calculate clusters of results for a specific security risk. The results plan used specifies that certain data is extracted and used in chart and report generation 306 in order to provide a user with some predefined (according to the results plan) results, such as a set of graphs for example. The results view interface allows a user with appropriate permissions to initiate chart and report generation using calculated data in order to provide results outside of the scope of the results plan. According to an example, the results used for such chart and report generation are pre-existing—that is, the use of the results view interface does not cause new data to be calculated, it allows a user to query data already present and which may not have been displayed to the user (such as data not displayed to a user because it is outside of the results pan scope for example). A results interface engine 503 is therefore able to use data in existing results clusters 103, 302.

Experiments interface engine 505 drives an experiments view interface 506 to provide a mode of operation of the system of FIG. 5 which allows a user with appropriate permissions to make queries which involve calculation of new results within the scope of the model being used. That is to say, the model 207 can be altered to an extent in order to allow results clusters 103, 302 to be augmented with additional data which the user desires. Accordingly, via the experiments view interface 506, the experiments interface engine 505 can vary parameters 204 used and/or ranges of parameters used and investments 203 for example. Accordingly, experiments interface engine 505 is operatively coupled to the model engine 200 for the purposes of varying investments 203, associated parameters 204 and/or ranges for parameters. Such changes cause risk analyzer 300 to calculate further result clusters 103, 302 using the extended search space. Such a mode of operation can be a mode which is considered to be more privileged than that associated with the results view interface mode of operation.

Model interface engine 501 drives a model view interface 502 to provide a mode of operation of the system of FIG. 5 which allows a user with appropriate permissions to make queries which involve a change in the model 207. For example, the interface 502 can be used to alter internal 201 and/or external 202 components for a model 207. Investments 203, parameters 204 and associated ranges can also be changed in this mode. Accordingly, model interface engine 501 is operatively coupled to the model engine 200 for the purposes of varying internal components 201, external components 202, investments 203, parameters 204 and/or ranges for parameters for a model. Such a mode of operation can be a mode which is considered to be more privileged than that associated with the experiments view interface mode of operation.

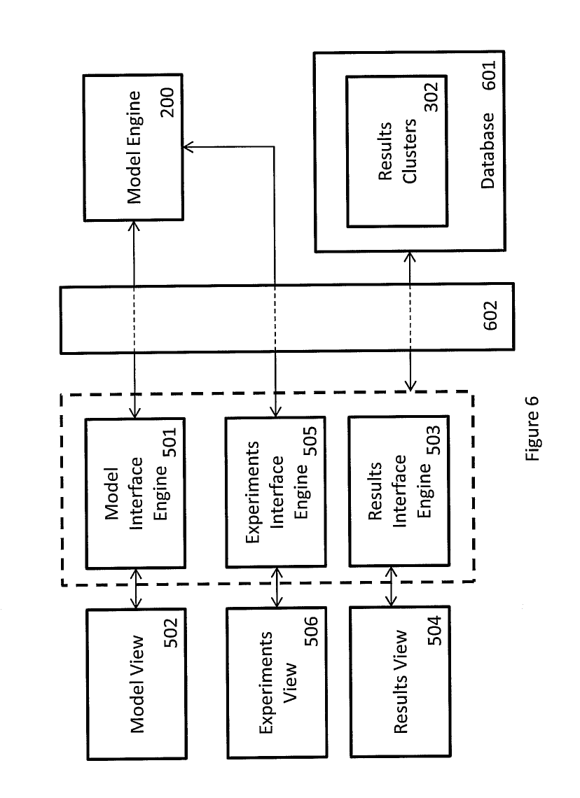

FIG. 6 is a schematic block diagram of a system according to an example. As described with reference to FIG. 5, modes of operation using a model view interface 502 and experiments view interface 506 include the provision of using the model engine 200 to change a model or aspects of a model. Both interfaces also have access via their respective engines 501, 505 to the results clusters 103, 302 so that existing data can be queried. Results view interface 504 has access to results clusters 103, 302 (via results interface engine 503). According to an example, results clusters 103, 302 can be stored in a database 601 which is accessible by engines 501, 505, 503 via a network 602. For example, the interfaces 502, 504, 506 can be web-based interfaces running in a browser such as Internet Explorer or Firefox or similar on a computing apparatus. Database 601 can be a database which is stored at a location which is remote from the apparatus and which communicates over a network 602 with the database 601. Network 602 can be a network which is internal to a company, such as a company intranet for example, or can be a public network such as the internet for example. Similarly, model engine 200 can be remotely queried over network 602. Alternatively, the database 601 and model engine 200 can be locally stored on a computing apparatus such as a desktop or laptop computer or other suitable device such as a mobile station.

According to an example, database 601 can store data representing packages as described above. In addition to unified packages/projects, database 601 can include information about people who have rights to access a package or project and a description of the package or project. The information can be stored as metadata for example.

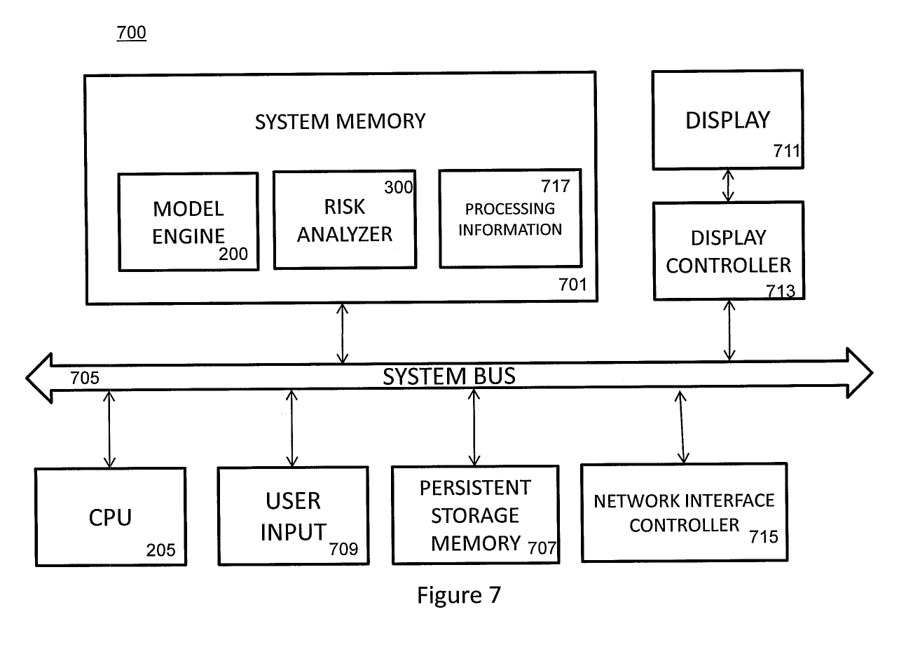

FIG. 7 is a schematic block diagram of a system according to an example. The system 700 includes a processing unit 205, a system memory 701, and a system bus 705 that couples processing unit 205 to the various components of the system 700. The processing unit 205 typically includes a processor, such as a multiple core processor for example, which may be in the form of any one of various commercially available processors. The system memory 701 typically includes a read only memory (ROM) that stores a basic input/output system (BIOS) that contains start-up routines for the system 700 and a random access memory (RAM). The system bus 705 may be a memory bus, a peripheral bus or a local bus, and may be compatible with any of a variety of bus protocols, including PCI(e), VESA, Microchannel, ISA, and EISA. The system 700 also includes a persistent storage memory 707 (e.g., a hard drive (HDD), a CD-ROM drive, magnetic tape drives, flash memory devices, and digital video disks) that is connected to the system bus 705 and contains a computer-readable media disk to provide non-volatile or persistent storage for data, data structures and computer-executable instructions.

A user may interact (e.g., enter commands or data) with system 700 using input devices 709 (e.g., a keyboard, a computer mouse, a microphone, joystick, and touch pad or touch sensitive display screen). Information may be presented through a user interface that is displayed to a user on the display 711 (implemented by, e.g., a display monitor which can be touch sensitive, including a capacitive, resistive or inductive touch sensitive surface for example), and which is controlled by a display controller 713 (implemented by, e.g., a video graphics card). Accordingly, any one of the interfaces 502, 504, 506 can be presented to a user using display 711. A user can then interact with the interface using input devices 709 in order to cause CPU 205 and memory 701 to effect aspects of the system 700.

The system 700 also typically includes peripheral output devices, such as speakers and a printer. A remote computer may be connected to the system 700 through a network interface card (NIC) 715. Alternatively, system 700 can upload retrieved data, or a pointer thereto, to a remote storage service such as cloud based service for example. For example, a database 601 can be stored on a cloud based storage service, and results clusters 103, 302 stored in database 601 can be queried over the network 602 using controller 715.

As shown in FIG. 7, the system memory 701 also stores model engine 200 and risk analyzer 300 as well as processing information 717 that can include results clusters 103, 302, an experiment plan 305 and a results plan 307. A model library 400, experiment plan library 507 and results plan library 508 can be stored in persistent storage 707, or accessed at a remote storage location (not shown) using network controller 715.

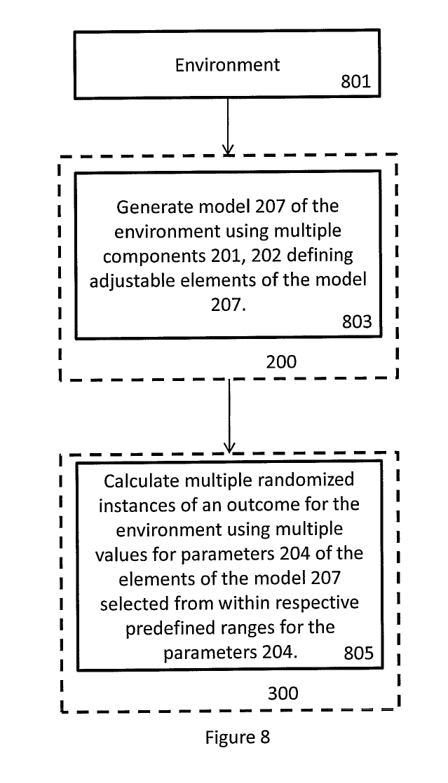

FIG. 8 is a block diagram of a system for analyzing an environment 801 according to an example. In block 803, a model engine 200 is used to generate a model 207 of the environment using multiple components 201, 202 defining adjustable elements of the model 207. In block 805, a risk analyzer 300 is used to calculate multiple randomized instances of an outcome for the environment using multiple values for parameters 204 of the elements of the model 207 selected from within respective predefined ranges for the parameters 204.

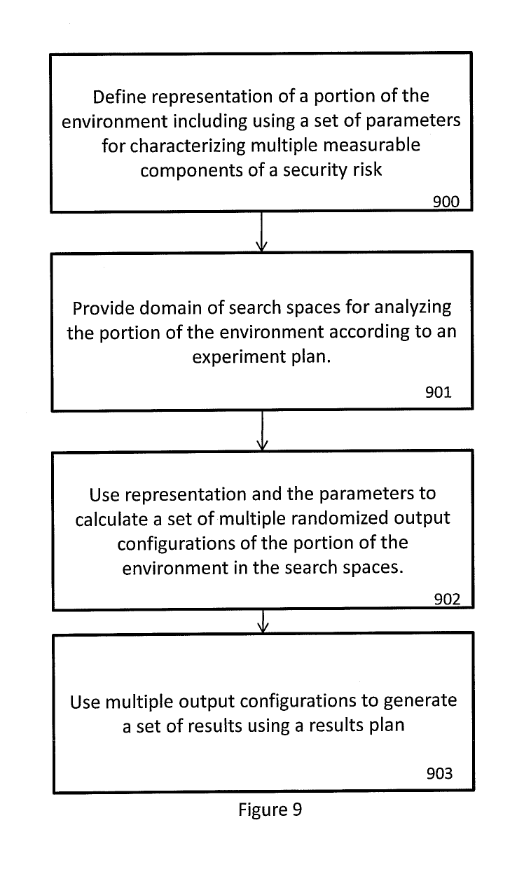

FIG. 9 is a schematic block diagram of a method according to an example. In block 900 a representation of a portion of the environment is defined including using a set of parameters for characterizing multiple measurable components of the security risk. In block 901 a domain of search spaces for analyzing the portion of the environment according to an experiment plan is provided. In block 902 the representation and the parameters are used to calculate a set of multiple randomized output configurations of the portion of the environment in the search spaces. In block 903 the multiple output configurations are used to generate a set of results using a results plan.

What is claimed is:

1. A system for analyzing an environment to identify a security risk, comprising:
a model engine to generate a model of the environment using multiple components defining adjustable elements of the model;
a risk analyzer to calculate multiple randomized instances of an outcome for the environment using multiple values for parameters of the elements of the model selected from within respective predefined ranges for the parameters.

2. A system as claimed in claim 1, further comprising multiple interface engines to drive respective interfaces to provide multiple modes of operation of the system with different privileges.

3. A system as claimed in claim 2, further comprising:
a network interface controller to control access from the multiple interface engines to a database for the system storing data representing a set of results clusters representing the multiple instances.

4. A system as claimed in claim 1, the risk analyzer operable to:
calculate multiple instances of an outcome for the security risk using an experiment plan from an experiment plan library.

5. A system as claimed in claim 1, the model engine further to:
provide access to multiple internal and external components and parameters for the model, the internal components including representations of tasks undertaken in security operations, a speed with which these tasks are undertaken and security solutions and mechanisms and their properties, the external components including representations corresponding to an external threat environment.

6. A system as claimed in claim 5, wherein the multiple internal and external components are provided as graphical representations for the system and wherein the model engine is further operable to use the graphical representations to compile respective machine readable instructions for the components.

7. A system as claimed in claim 1, the risk analyzer operable to:
generate results representing an outcome for the security risk using a results plan from a results plan library.

8. A method for analyzing an environment to identify a security risk comprising:
defining a representation of a portion of the environment including using a set of parameters for characterizing multiple measurable components of the security risk;
providing a domain of search spaces for analyzing the portion of the environment according to an experiment plan;
using the representation and the parameters to calculate a set of multiple randomized output configurations of the portion of the environment in the search spaces; and
using the multiple output configurations to generate a set of results using a results plan.

9. A method as claimed in claim 8, wherein defining a representation includes using a template from a model library to characterize the portion of the environment in response to a determination of multiple investment choices associated with the security risk.

10. A method as claimed in claim 8, wherein calculating a set of multiple randomized output configurations includes using a random number generator to set multiple values for respective ones of the parameters.

11. A method as claimed in claim 8, further comprising adjusting a measurable component of the representation in response to an output configuration.

12. A method as claimed in claim 8, further comprising:
providing multiple interface views with different access privileges to control access to respective interface engines for changing the representation, experiment plan and results plan.

13. A method as claimed in claim 12, further comprising:
providing multiple projects stored in a database, each project including data representing a model template, experiment plan and results plan and metadata associated with the project including a description for the contents of the project and access control data defining access rights for a user accessing the database using an interface view.

14. A method as claimed in claim 13, wherein projects are visible to a user on the basis of the interface view used to access the database and according to the access privileges of the user.

15. A method as claimed in claim 8, wherein the multiple measureable components are provided as respective graphical representations which map to machine readable instructions for the components.

16. A machine-readable medium storing machine-readable instructions arranged to be executed on a machine, the instructions comprising:
to receive data for a model representing an environment in which a security risk exists including an associated parameter for mitigating the security risk;
to receive data representing an interval in which the parameter can be varied;
to receive data representing a randomized value for the parameter from within its associated interval;
to execute the model using the randomized value to calculate data for an output configuration for the environment;
to receive data representing selection criteria for selecting a subset of the data for the output configuration; and
to display data for the subset using a display to enable mitigation of the security risk.

17. The machine-readable medium as claimed in claim 16, further including machine-readable instructions to:
determine a set of components in the model;
compile machine-readable instructions for the determined components to provide an executable version of the model.
